(19) United States
(12) Patent Application Publication
(10) Pub. No.: US 2010/0077641 A1
(43) Pub. Date: Apr. 1, 2010

(54) PLACARD HOLDER

(76) Inventor: Richard L. GREENWALD, Hartford, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/547,717

(22) Filed: Aug. 26, 2009

Related U.S. Application Data
(60) Provisional application No. 61/101,803, filed on Oct. 1, 2008.

(51) Int. Cl. G09F 7/00; G09F 21/04

(52) U.S. Cl. 40/611.11

(57) ABSTRACT

A placard holder is a unitary structure having a left side, a right side and a bottom. Each of the left side, right side and bottom comprise the portions of a folded over, partial “capture” means, or partial “frame,” specifically comprising a left side frame, a right side frame and a bottom frame. The top of the placard holder is frameless such that a cautionary placard can be inserted into the partial frame that is created by the left side frame, the right side frame and the pair of bottom frames. In the preferred embodiment, the frames are folded-over portions of a unitary metal structure that forms the holder. The holder is attachable to a vehicle or other transport means for use when hazardous items are transported, the placard that is inserted into the holder being cautionary.

This application claims the benefit and priority of United States Provisional Patent Application No. 61/101,803 filed Oct. 1, 2008.

### FIELD OF THE INVENTION

The present invention relates generally to signs and signage. More specifically, the present invention relates to placards for use with over-the-road trucks and to holders for such placards.

### BACKGROUND OF THE INVENTION

Federal regulations designate specific materials as hazardous for purposes of transportation (49 C.F.R. Sec. 172.101). For each hazardous material, U.S. regulations further specify requirements for identifying these hazardous materials when being transported with vehicles such as trucks, truck trailers, trains, tank cars, cargo tanks and other transport vehicles. The specified hazardous materials are currently placed in a plurality of categories based on their chemical and physical properties. These categories include: Class 1—Explosives; Class 2—Gases; Class 3—Flammable liquids; Class 4—Flammable solids, spontaneously combustible materials and materials that are dangerous when wet; Class 5—Oxidizers and organic peroxides; Class 6—Poisons and etiologic materials; Class 7—Radioactive materials; Class 8—Corrosives; Class 9—Miscellaneous; and ORM-D—Other regulated material.

The U.S. Department of Transportation requires placarding of vehicles to notify the transportation workers, emergency workers and the public in general to the presence and type of hazardous materials contained in the vehicles. The placards are required to have specific indicia such as graphics, text, and color that classify the hazardous material being transported by the vehicle.

Trucks and other transportation vehicles have the capacity to transport different types of hazardous material. Thus, the placards affixed to the vehicle must periodically be reconfigured to reflect the different material being contained in the vehicle. One inexpensive method of is applying hazard classification placards includes affixing adhesive labels directly to the surface of the vehicle which have the proper size, shape and correct indicia to correspond to a placard under U.S. regulations. Another method of affixing placards to vehicles includes the use of placards in the form of rigid pages that are hinged to the side of the vehicle. Multiple pages representative of different hazard class placards may be hinged to the vehicle. When a different material is placed in the vehicle, the pages may be flipped to display the placard corresponding to the hazard class of the new material.

Transportation regulations have been recently changed to require placarding of vehicles carrying Polychlorinated Biphenyls (PCBs). The placard is required to be on all four sides of a trailer. Additionally, the placard must be separate and apart from other placards such that identification of this specific hazard is clear for emergency responders. As a result, there is a need for a new type of placard holder for PCBs and for other specially classified hazardous materials.

### SUMMARY OF THE INVENTION

The claimed invention provides a safety classification placard holder for use with over-the-road trucks and other vehicles that may need such a device. The claimed invention further provides a novel means for securing the placard within the placard holder. The claimed invention also provides for easy removal of the placard holder, which is required when the vehicle is no longer carrying hazardous materials. The claimed invention also provides a means for mounting the placard holder to a vehicle or trailer, as may be required.

The placard holder of the present invention has a left side, a right side and a bottom. Each of the left side, right side and bottom comprise the portions of a folded over, partial “capture” means, or partial “frame,” specifically comprising a left side frame, a right side frame and a bottom frame. The top of the placard holder is frameless such that a cautionary placard can be inserted into the partial frame that is created by the left side frame, the right side frame and the pair of bottom frames. In the preferred embodiment, the frames are simply folded-over portions of a unitary metal structure that forms the holder.

The foregoing and other features of the holder of the present invention will be apparent from the detailed description that follows.

### BRIEF DESCRIPTION OF THE DRAWINGS

FIG. 1 is a top, front and right side perspective view of the placard holder of the present invention showing a cautionary placard, in phantom view, retained within the holder.

FIG. 2 is a front elevational view of the placard holder.

FIG. 3 is a top plan view of the placard holder.

FIG. 4 is a right side elevational view of the placard holder.

FIG. 5 is a cross-sectional and top plan view of the placard holder taken along line 5-5 of FIG. 2.

### DETAILED DESCRIPTION OF THE DRAWINGS

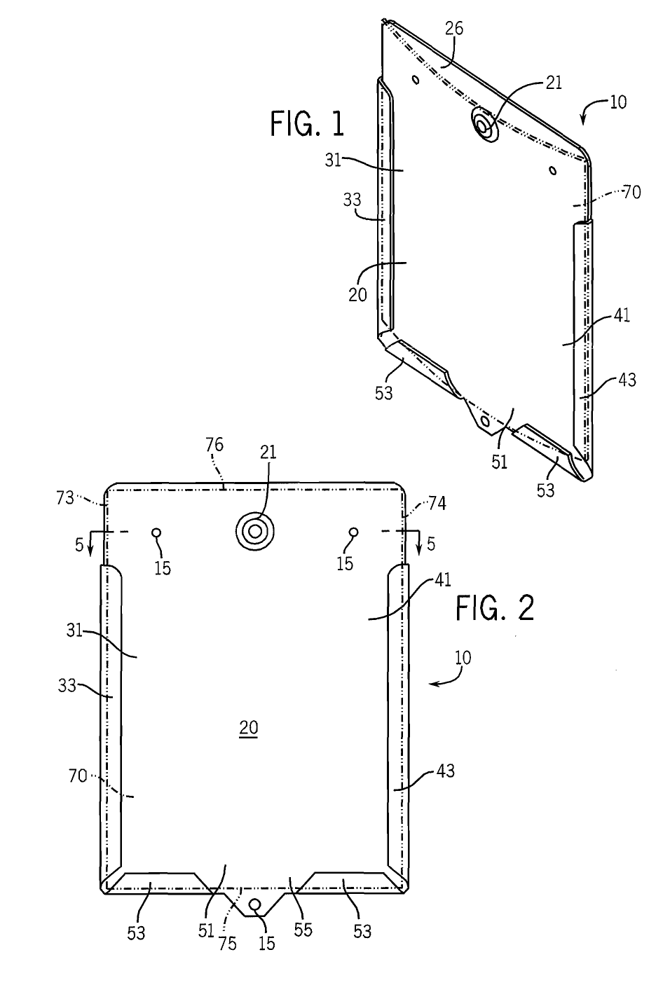

Referring now to the drawings in detail wherein like reference numerals refer to like elements throughout, FIG. 1 shows a perspective view of a device, generally identified 10, that is constructed in accordance with the present invention. This device 10 is specifically identified herein as a “placard holder.” The placard holder 10 illustrated may be attached or mounted to a vehicle (not shown), a trailer (also not shown) being pulled by a vehicle, or other such movable cargo-carrying items such as trains, tank cars and cargo tanks (also not shown), each by means of a plurality of fasteners (also not shown). It is to be understood that the fasteners can be any type of known fastener that can be inserted through apertures 15 that are formed in the flat planar back 20 of the placard holder 10 and anchored to the mounting surface behind the holder 10.

In the preferred embodiment, the placard holder 10 is made of a metal material, chosen by this inventor for durability, resistance to rust and corrosion, and ready availability. The placard holder 10 could, however, be made of other materials. Also in the preferred embodiment, the placard holder 10 is made of a unitary structure. In this way, sheet metal material can be stamped and pressed to easily form the unitary structure, which reduces the cost and time of fabrication.

The flat planar back 20 of the holder 10 further comprises a front face 22 that faces outwardly of the mounting surface to which the holder 10 is attached and a rear face 24 that lies adjacent that mounting surface. The flat planar back 20 of the placard holder 10 further has a forwardly-projecting member, or boss, 21 disposed at the upper portion 26 of the back 20.

Referring now to FIG. 2, it can be seen that the placard holder 10 has a left side 31, a right side 41 and a bottom 51. Each of the left side 31, right side 41 and bottom 51 comprise the portions of a folded over, partial “capture” means, or partial “frame,” specifically comprising a left side frame 33, a right side frame 43 and a bottom frame 53. The top 61 of the placard holder 10 is frameless such that a cautionary placard, identified in phantom view generally as 70, can be inserted into the partial frame that is created by the left side frame 33, the right side frame 43 and the pair of bottom frames 53. In the preferred embodiment, the frames 33, 43, 53 are simply folded-over portions of the unitary metal structure that forms the holder 10.

As shown, the bottom frames 53 are not, and need not be, continuous so long as the bottom frames 53 are sufficiently capable of supporting the placard 70 from the bottom. In fact, it is advantageous if there is some open area 55 between the two bottom frames 53 such that upward pressure can be easily applied by the user to the placard 70 at or near its center 72 to urge the placard 70 upwardly for removal from the holder 10 when removal is desired or required.

As alluded to earlier in this specification, transportation regulations have been recently changed to require the placarding of vehicles carrying PCBs. The cautionary placard 70 is required to be on all four sides of a trailer. Additionally, the placard 70 must be separate and apart from other placards such that identification of this specific hazard is clear for emergency responders.

Placards 70 of the type intended to be used with the holder 10 of the present invention are typically relatively stiff items made of sheet-like plastic or phenolic material so that they can withstand the normal buffeting and rough use associated with being placed on the side of a moving transport vehicle. The cautionary placard 70 typically comprises indicia (not shown) in the form of a visual image and cautionary lettering, all for the purpose of clearly identifying the hazardous condition presented by the vehicle carrying its load. Additionally, placards 70 must be used and re-used, inserted and removed, multiple times.

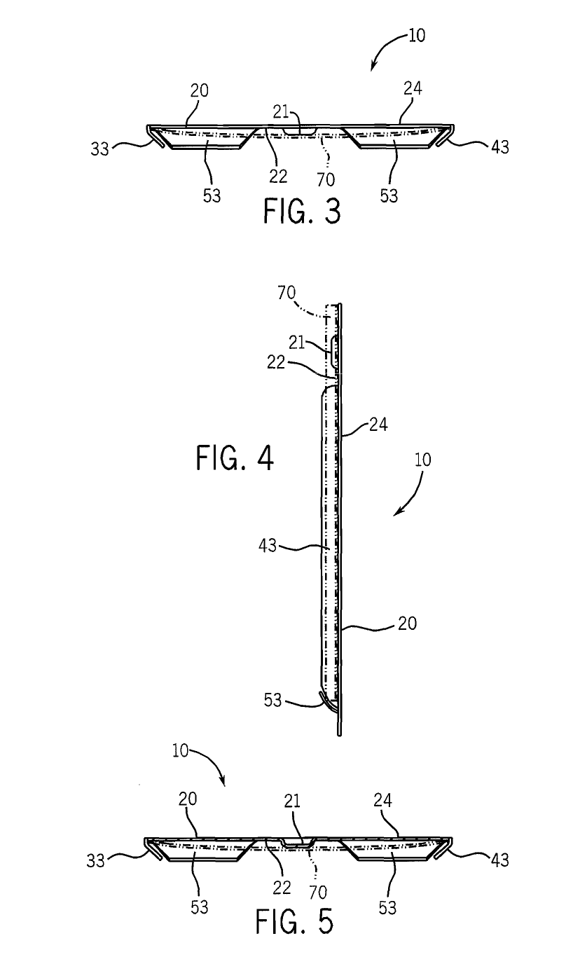

When inserted into the placard holder 10 of the present invention, the left side 73, right side 74 and bottom 75 of the placard 70 is constrained by the left side frame 33, the right side frame 43 and the bottom frames 53, respectively. While the top 61 of the placard holder 10 is relatively open by comparison, the placard 70 is firmly constrained in place by means of the forwardly-projecting boss 21. As shown in FIGS. 3 and 5, the boss 21 is sufficiently prominent to urge and flex the upper portion 76 of the placard 70 slightly outwardly and forwardly after the placard 70 is inserted. This results in the placard 70 being firmly held within the holder 10 by a minimum of four points of contact, one on each edge 73, 74, one on the bottom 75 and one on the top 76 of the placard 70. Likewise, when the placard 70 needs to be removed, the placard 70 may be flexed, bowed or deformed even more so that it can be urged and moved upwardly, such as by upward pressure in the area 55 between the bottom frames 53, thereby overcoming the force exerted on the placard 70 by the boss 21.

In practice, a placard 70 may be installed rapidly and with no tools by merely sliding the placard 70 into the placard holder 10 along the left side frame 33 and the right side frame 43 until the placard is on contact with the bottom frames 53. At that time, the top 76 of the placard 70 should be in front of the boss 21 and should be retained within the holder 10 by the boss 21 under virtually any weather or traffic conditions. To remove the placard 70 from the placard holder 10, one can also use a slim instrument or one's hand and fingers to deform the placard 70 slightly in the area 76 of the boss 21 such that the top 76 of the placard clears the boss 21 and then apply upward pressure on the bottom 75 of the placard 70.

Based upon the foregoing, it will be apparent that there has been provided a new, useful and non-obvious placard holder 10 for use with over-the road trucks and other vehicles that permits the rapid installation and removal of cautionary placards 70 for use in providing warnings to emergency personnel as to the contents being transported.

I claim:

1. A placard holder for use with over-the-road trucks and other vehicles comprising:
a flat planar back having a top edge, a left side edge, a right side edge and a bottom edge;
a left side extending forwardly of the left side edge of the back and comprising a left side frame;
a right side extending forwardly of the right side edge of the back and comprising a right side frame;
a bottom extending forwardly of the bottom edge of the back and comprising a bottom frame; and
a boss defined within the back and projecting forwardly of the back near the top edge of the back;
wherein a placard placed within the holder is retained by the left side frame, the right side frame and the bottom frame when urged forwardly by the boss.

2. The placard holder of claim 1 wherein the back, the left side frame, the right side frame, the bottom frame and the boss are integrally-formed as a unitary structure.

3. The placard holder of claim 2 wherein the holder is made from a sheet of metal material.

4. The placard holder of claim 3 wherein the frames of the holder are formed by folded-over portions of the unitary metal sheet that forms the holder.

5. The placard holder of claim 4 wherein apertures for fasteners are defined within the flat planar back of the holder.

6. A metal device for holding a cautionary placard, the device comprising a single sheet of metal material and further comprising:
a flat planar back having a top edge, a left side edge, a right side edge and a bottom edge;
a left side extending forwardly of the left side edge of the back and comprising a left side frame;
a right side extending forwardly of the right side edge of the back and comprising a right side frame;
a bottom extending forwardly of the bottom edge of the back and comprising a bottom frame; and
a boss defined within the back and projecting forwardly of the back near the top edge of the back;
wherein the back, the left side frame, the right side frame, the bottom frame and the boss are integrally-formed as folded-over portions of the unitary structure; and
wherein a placard placed within the device is retained by the left side frame, the right side frame and the bottom frame when urged forwardly by the boss.

7. The device of claim 6 wherein apertures for fasteners are defined within the flat planar back of the device.
